(19) United States
(12) Patent Application Publication
(10) Pub. No.: US 2018/0336382 A1
(43) Pub. Date: Nov. 22, 2018

(54) Systems and Methods for Generating Alert to Avoid Misplacement of a Device or Item

(71) Applicants: Ann Sacks, Portland, OR (US); Sean S. McGinley, Providence Forge, VA (US)

(72) Inventors: Ann Sacks, Portland, OR (US); Sean S. McGinley, Providence Forge, VA (US)

(73) Assignee: FetchFind LLC, Portland, OR (US)

(21) Appl. No.: 15/981,274

(22) Filed: May 16, 2018

Related U.S. Application Data
(63) Continuation of application No. 62/507,014, filed on May 16, 2017.

(51) Int. Cl. G06K 7/10; G06K 19/077; H04W 4/029

(52) U.S. Cl. CPC G06K 7/10386; H04W 4/029; G06K 7/10445; G06K 19/07758

(57) ABSTRACT

A system, device and processes that can provide a user with a way to prevent the loss or misplacement of an item of value. In some embodiments, a wireless communications technology, such as a Bluetooth module (e.g., Bluetooth Low Energy, BLE) or similar functional module is embedded in, or otherwise incorporated into the item of value. For example, an embodiment may utilize the Bluetooth communications capability of a smartphone, laptop, or tablet computer. In this embodiment, an alert component in the possession of a user communicates with the Bluetooth module associated with the item of value.

### CROSS REFERENCE TO RELATED APPLICATIONS

This application claims the benefit of U.S. Provisional Application No. 62/507,014, entitled “System and Methods for Generating Alert to Enable Retrieval of Misplaced Device or Item,” filed May 16, 2017, which is incorporated by reference herein in its entirety (including the Appendix) for all purposes.

### BACKGROUND

People often misplace an item of importance or relatively high value; such items may include a smart phone, laptop computer, eyeglass frames, wristwatch, purse, wallet, radio, tools, jewelry, etc. These devices or items are of relatively high value and may contain data or information that is private; because of this, retrieving the item or device quickly is of great importance to a user. However, conventional approaches to informing a user that they have left an item or device behind suffer from one or more disadvantages, such as bulk, difficulty to configure, interfering with the normal operation of the device, etc.

Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are related to a system, device and processes that can provide a user with a way to prevent the loss or misplacement of an item of value. In some embodiments, a wireless communications technology, such as a Bluetooth module (e.g., Bluetooth Low Energy, BLE) or similar functional module is embedded in, or otherwise incorporated into the item of value. For example, an embodiment may utilize the Bluetooth communications capability of a smartphone, laptop, or tablet computer. In this embodiment, an alert component in the possession of a user communicates with the Bluetooth module associated with the item of value.

Another embodiment may include attaching a Bluetooth communications module to an item of value, such as jewelry. Other embodiments may involve attaching a tracking component to the item of value. In embodiments using an attached tracking component, the tracking component may include a Bluetooth communications module (such as a BLE module) mounted on a circuit board (along with other elements or components, such as an antenna, an alert source and a source of power) and encased in a container formed from plastic or another suitable material.

In one or more of the embodiments discussed, a user may be alerted that an item of value has been misplaced and potentially lost by use of an alert component in their possession. The alert component may be a stand-alone component attached to a key ring, jacket, necklace, etc., or may be incorporated into an object that is in possession of the user, such as the user's eyeglass frames. The alert component may include an antenna, a BLE module, an alert source and a source of power. The alert source is an element capable of generating an alert signal, such as one or more of a source of a visual (such as a LED), audible (such as a micro-speaker for generating an alert tone or tones), or haptic (for generating a vibration) signal.

As noted, in some embodiments, an alert component may be in possession of a user and attached to a key ring or other object carried by the user. When the alert component detects a change or sufficient decrease in signal strength from a BLE module with which it is paired, the component may alert a user (using one or more of a visual, audible, or haptic alert signal) that they are in danger of leaving the vicinity of whatever object contains or is associated with the BLE module (such as a pair of eyeglass frames, an item of value that includes a Bluetooth communications capability, or an item of value to which a tracking component is attached).

In one embodiment, the invention is direct to . . .

In another embodiment the invention is directed to . . .

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1(a) is a block diagram of the primary functional components or elements of a system that may be used to prevent the loss of an item of value;

FIGS. 1(b) and 1(c) are diagrams illustrating certain of the elements of an embodiment of an alerting and/or tracking component 100 that may be attached to an item of value or be in possession of a user, as part of a system for preventing the loss of the item of value;

FIG. 1(d) is a schematic diagram of a circuit and components that may be used to construct an embodiment of the alerting and/or tracking component described herein and illustrated in FIGS. 1(b) and 1(c);

FIG. 1(e) is a flowchart or flow diagram illustrating aspects of a process, operation, method, or function that may be used to assist a person to prevent the loss of an item of value;

FIG. 2(a) is a diagram illustrating views of an embodiment of an alerting and/or tracking component 200 that may be attached to an item of value or be in possession of a user, as part of a system for preventing the loss of the item of value;

FIG. 2(b) is a parts list and illustration of an embodiment of the alerting and/or tracking component of FIG. 2(a);

FIGS. 3(a) and 3(b) are diagrams illustrating top angled views of the Fetch Eyewear “Bella” Frames with embedded Bluetooth modules. Note that the Fetch Eyewear Bella frame is not a requirement of an embodiment of the invention, and is being shown as an example of a frame in which a Bluetooth or similar alerting or tracking module could be embedded;

FIG. 3(c) is an illustration of the alerting or tracking component embodiment of FIG. 1(a) as it might be embedded or incorporated with the example frames of FIG. 3(a) or 3(b);

FIG. 4 is a diagram illustrating elements or components some of which may be present in a computing device, mobile device or system configured to implement a method, process, function, or operation in accordance with an embodiment of the invention; and

FIG. 5 is a flowchart or flow diagram illustrating a method, process, operation, or function(s) that may be implemented by an embodiment of the inventive system and methods in order to assist a user to not misplace or lose an item of value.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Some embodiments of the system and methods described herein are related to an alerting component that includes a Bluetooth communications module (such as a BLE module) and micro-speaker (or other form of alert generating element, such as a visual indicator/LED or haptic signal generator), placed in a plastic or other type of material encasement in possession of a user. Once paired with a mobile device (such as a phone, tablet, or laptop having a Bluetooth communications capability), the alerting component will provide users with a way to be alerted when leaving the vicinity of their mobile device prior to leaving the area completely; this will operate to help and/or prevent the loss or misplacement of their mobile device.

Other embodiments are related to use of a similar component as a tracking component that is attached to an item of value (such as a smartphone, laptop, tablet, valuable tool, tool chest, wallet, purse, suitcase, etc.) and paired with a Bluetooth communications module in a user's smartphone, eyeglass frames, or alerting component that is in possession of the user.

In general, embodiments and use cases of the system and methods described herein belong to one of the two following categories:
use cases in which a tracking component is attached to an item of value (e.g., a mobile device such as a smartphone, tablet or laptop, or a wallet, purse, tool chest, etc.) and a Bluetooth module (such as Bluetooth low energy, BLE) embedded in a user's eyeglass frames, device, or alerting component in a user's possession communicates with a similar module in the tracking component; and
use cases in which an alerting component is in the possession of the user and a Bluetooth module (such as BLE) in the alerting component communicates with a similar module or capability incorporated in an item of value (such as a smartphone, laptop, tablet, item of jewelry, tool chest, wallet, purse, etc.).

As further examples, possible use cases for an embodiment include one or more of the following:
an alerting component is attached to a key ring or something else that is generally in a user's pocket; this component is paired with a BLE module contained in an item of value (smartphone, laptop, tablet, etc.). Using an emitted signal as a control (sometimes referred to as a “heartbeat”), a light, speaker or source of a haptic signal that is part of the alerting component generates a signal or indicator when the component/user becomes too far away from the item of value (as recognized by a change in the signal strength, for example, a specific amount of decrease in signal strength, a percentage decrease from an initial value, a relative signal-to-noise ratio, etc.);
   in another embodiment, the BLE module in the alerting component is paired with a BLE module that is contained in a tracking component which is attached to the item of value; or
in another embodiment, aspects of the alerting component are integrated into a pair of eyeglass frames and include an alert generating capability (e.g., micro speaker, visual indicator, whistle, vibrational element). In this case, when the frames are paired with a BLE module incorporated in the item of value or in a tracking component attached to the item, then the user's eyeglasses will alert the user when they leave the item of value behind;
   a variation of this embodiment is to use a BLE communications capability and source of an alert that are part of a mobile device (such as a smartphone) paired with a BLE module in a user's frames to alert the user when they may be about to leave their frames behind (note that this embodiment is discussed in greater detail in U.S. patent application Ser. No. 15/784,503, entitled System and Methods for Using Bluetooth and GPS Technologies to Assist User to Find Eyeglasses or Other High Value Item, filed Oct. 16, 2017), which is assigned to the same entity as the present application.

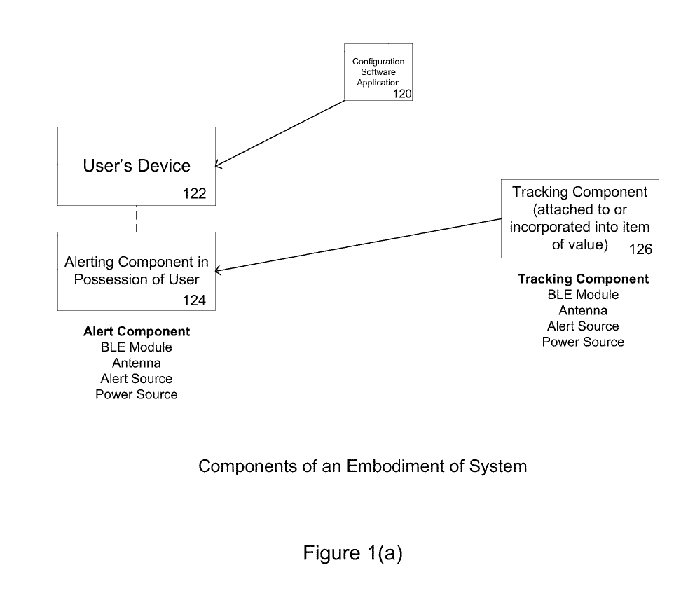

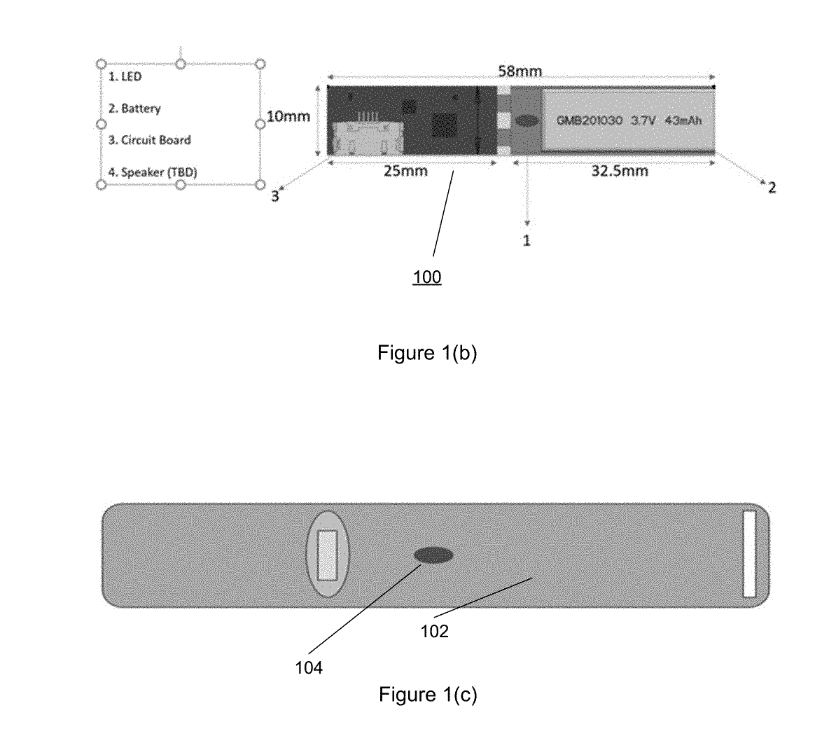

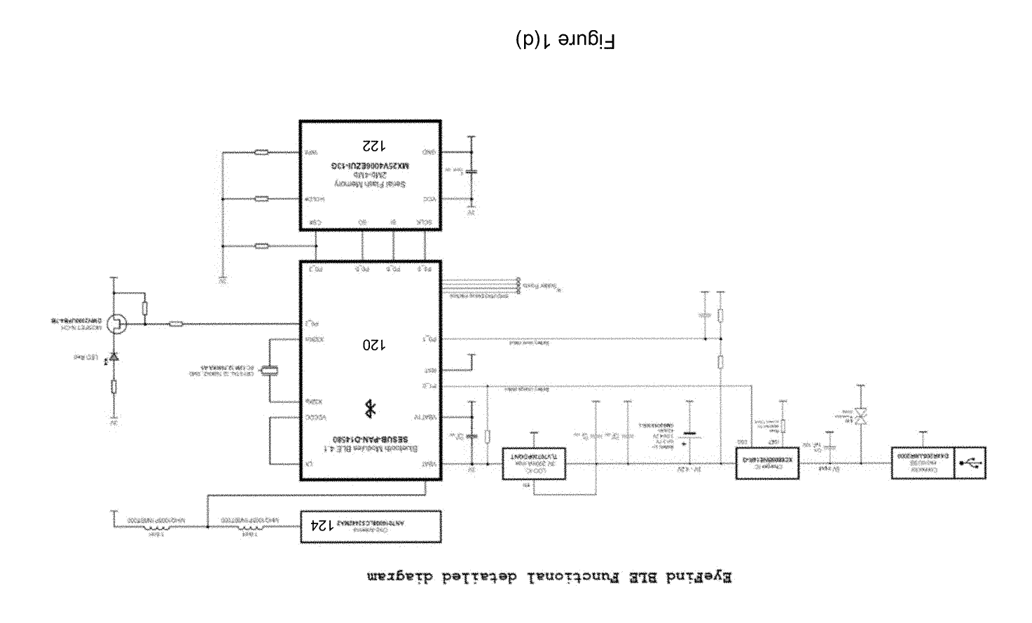

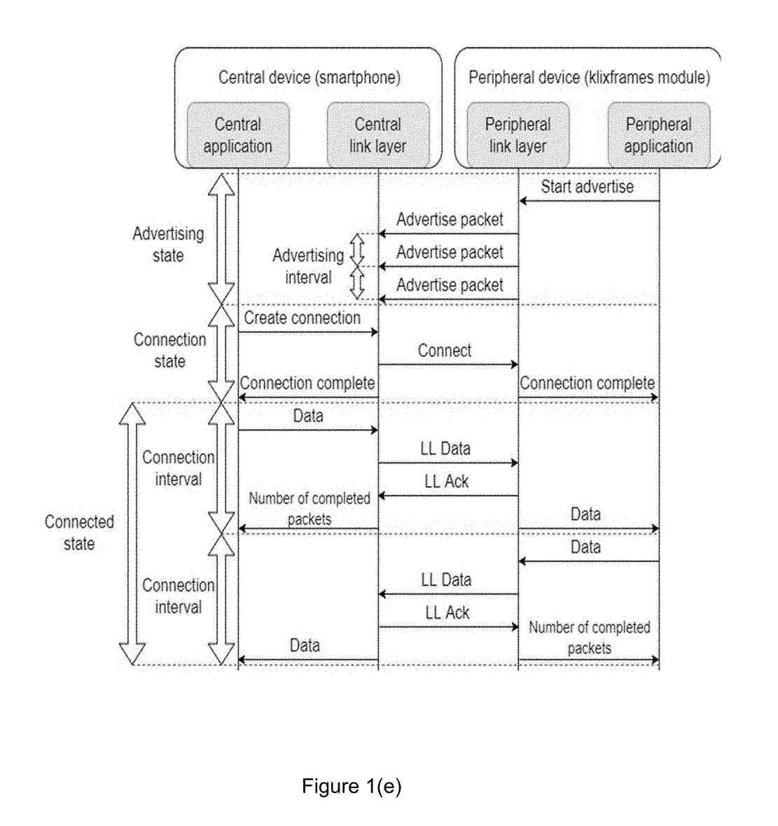

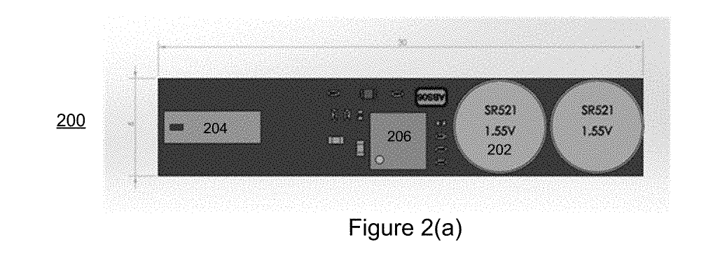

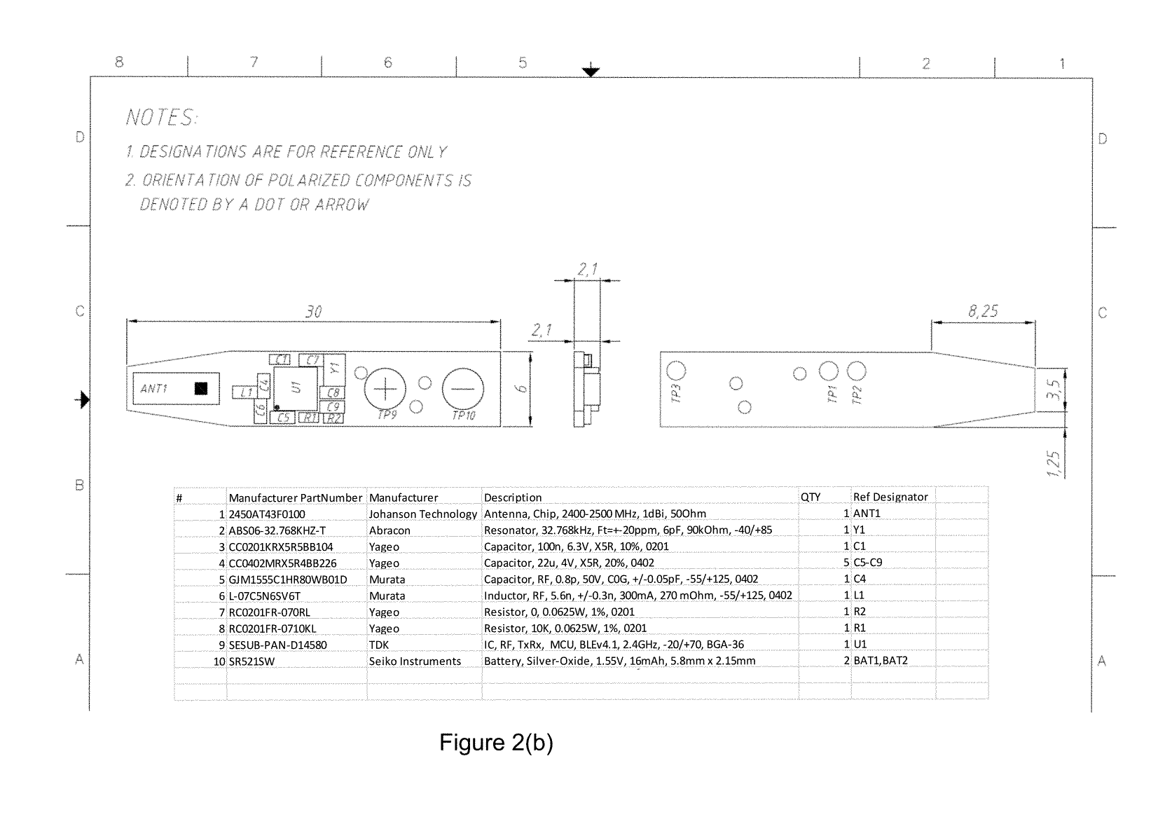

As will be described in greater detail, one or more embodiments of the system and methods relate to use of a BLE module in possession of the user that communicates with a similar module that is incorporated into or attached to an item of value. The BLE module (or other equivalent form of transmitting a signal) may be part of an alerting or tracking component of the type described with reference to FIGS. 1 and 2, or may be incorporated or embedded into a device or item. In some cases, the BLE module may be used to provide a functional capability to the item (such as is the case with a smartphone, laptop, or tablet) and in other cases, the BLE module may be added to the item to provide a tracking capability; this would typically be the case for an item such as a piece of jewelry, a valuable piece of equipment, a wallet or purse, etc. In one or more embodiments, an alert generating capability may be part of an alerting or tracking component or be controlled by the component. Such an alert generating capability may include one or more of a visual alert (such as a LED), an audible alert (such as provided by the output of a speaker), or a haptic signal (such as a vibration).

In one or more embodiments, a BLE (Bluetooth low energy) module in an encasement and attached to an item of value is used to alert a user by emitting an audio alarm (and if desired and capable, a vibration or visual signal) when an emitted “heartbeat” or other signal from another BLE module is sufficiently reduced in signal strength or lost. In these embodiments, the detection of the heartbeat or other signal is used to indicate that the item of value is in range or nearby the source of the heartbeat (which may be a BLE module embedded in a user's eyeglass frames, for example). When a heartbeat is no longer detected (or the signal has been reduced to a specified level or relative amount due to the item of value and the frames being sufficiently separated), the frames may inform the user that they are in danger of leaving the item behind) by generating a suitable alert, such as one or more of an audible and/or visual indicator using a light, LED, or micro-speaker embedded into the frames. This lets the user know that they are leaving or have just left the vicinity of their mobile phone or other item of value. This provides the user with a warning that they may be about to lose the item of value and ideally causes them to look for the item where it was last used. In a variation, the item of value (such as a mobile device) may instead (or also) be caused to emit an alert, such as an audible tone or flashing lights, to assist those nearby to locate the item and return it to its owner.

As mentioned, in one or more embodiments, a BLE module embedded in a user's eyeglass frames emits a regular signal or “heartbeat” or other signal which may be detected by the tracking component which is attached to the user's mobile device or other item of value. A decrease in the strength of a received signal may be used to trigger an alert, tone, message, etc. Note that although the embedding of a Bluetooth module into eyeglass frames is discussed in some of the examples, such a module may be embedded in other items that a user is likely to keep on their person; these may include, for example, a watch, bracelet, key fob, etc.

In some embodiments, a downloaded software application may be installed on a user's smartphone or other device and used to permit the user (e.g., the owner of the item of value) to perform one or more of the following:
specify the type or types of alert (one or more of audible, visual, text, vibrational) that is generated when the heartbeat or signal cannot be detected or has been reduced in signal strength by a specified amount or relative amount, and therefore it is presumed that the user has left or is leaving the vicinity of the item of value;
configure the condition(s) under which such an alert is generated (such as the signal strength, decrease in signal strength, relative signal strength, SNR, etc.);
and
configure which possible sources of an alert are caused to generate an alert when a condition is satisfied;
   note that this may include one or more of an alerting component in the possession of the user, a source of an alert incorporated into a user's eyeglass frames, a source of an alert incorporated into the item of value, or a source of an alert in a tracking component attached to the item of value.

In one example use case, the Bluetooth BLE module embedded in a user's eyeglass frames (or other item typically in possession of the user) may be used to emit a heartbeat or other signal that is received by the tracking device attached to or incorporated into a phone, tablet, laptop or other item of value. When the user is moving away from a device or item of value they have misplaced or left behind, the decrease in signal strength and/or interruption in receipt of the heartbeat/signal may be used to trigger the generation of an audible alert by the eyeglass frames and/or by the mobile device or item. In this way the Bluetooth module (which may be embedded in a watch, bracelet, key fob, eyeglass frames, or other item or device that is in the possession of the user) is used to communicate with another device and to indicate when that other device is becoming out of range of the user who is in possession of an item with the embedded Bluetooth module.

As described with reference to FIG. 1(a), in some embodiments, an application 120 may be downloaded from a suitable location (such as a URL associated with a provider of the services described herein) and installed on a user's phone or other device 122. The software application 120 may permit a user to perform one or more of the following operations or configurations:
specify the type or types of alert (one or more of audible, visual, text, vibrational) that is generated when the heartbeat/signal cannot be detected or has been reduced in signal strength by a specified amount or relative amount, and therefore it is presumed that the user has left or is leaving the vicinity of the item of value;
configure the condition(s) under which such an alert is generated (such as the signal strength, decrease in signal strength, relative signal strength, etc.); and
configure at what component or device the alert or alerts are generated and/or received by the user (e.g., the user's eyeglass frames, an alerting component in possession of the user, a source of an alert that is incorporated into a mobile device or item of value, or a mobile device or an item to which a tracking component is attached).

Note that in this embodiment, an item that is assumed to be in the possession of the user acts as an element of a system designed to alert the user when they have misplaced or are about to leave behind a phone, tablet, laptop or other item of value to which is attached a tracking component that includes a Bluetooth BLE module, an alert generating component (e.g., a speaker or other source of an alert signal, such as LED or other visual indicator, a vibration generating element) and certain operational logic. In some embodiments, the BLE module that is part of the tracking component may be incorporated or embedded into an item of value.

The user has in their possession a device, component, or element that is capable of generating an alert (referred to as an “alerting component” 124 in the figure). Alerting component 124 may include the following elements or components:
BLE Module;
Antenna;
Alert Source;
Power Source;
Operational logic (such as a circuit board, digital logic circuit, etc.).

Note that in some embodiments, the alerting component may be similar in design to the tracking component; in other embodiments, the alerting component may be incorporated in an item in possession of the user (such as the user's device, an attachment to a key ring, etc.).

A tracking component 126 is attached to or otherwise incorporated into an item of value. Tracking component 124 may include the following elements or components:
BLE Module;
Antenna;
Alert Source;
Power Source;
Operational logic (such as a circuit board, digital logic circuit, etc.).
   Note that in some embodiments, only certain elements or functionality of the tracking component may be incorporated into the item of value; for example, the BLE module may be attached to or incorporated into the item of value, with the remaining components not present, or only in the alerting component.

Embodiments of the system, devices, and methods described herein assist an owner of a mobile device or other item of value (such as a laptop, tablet, jewelry, tools, a wallet, etc.) to not leave their mobile device or item of value behind when leaving the vicinity of the device or item. In some embodiments, this is accomplished by embedding or sealing a tab, module, or transponder in a plastic encasement that can be attached to an item of value. The elements of such a tracking component (or in some cases, an alerting component) are described in greater detail with reference to FIGS. 1(b)-(e) and 2(a)-(d).

The alerting or tracking component described with reference to FIGS. 1 and 2 and associated methods will provide users with a way to significantly reduce the possibility of losing an item of value. In one embodiment, when the Bluetooth technology enabled module in the tracking component is paired to a similar module embedded or attached to a user's eyeglass frames, the combination will enable a user to determine when they are leaving the vicinity of their mobile device or whatever item the component is attached to because of an alert generated by an indicator that is part of the frames (such as a visual indicator, haptic signal generator, or micro-speaker).

In another embodiment, when a Bluetooth enabled module attached to or incorporated into an item of value is paired to the Bluetooth technology enabled module in an alerting component, the combination will enable a user to determine when they are leaving the vicinity of the item of value to because of an alert generated by an indicator that is part of the alerting component, which is in the possession of the user.

Thus, if the user accidentally leaves their mobile device or other item of value on a restaurant table, in between the seats of a train, in a movie theatre, etc., the owner will be alerted once the distance between the module in the alerting component in possession of the user and the module associated with the item of value exceeds a specified or determined distance of separation, or of signal strength value or signal strength reduction. In one embodiment, as the user gets closer in proximity to the item of value, the rate or repetition of the audible (or other forms of) alert(s) generated may begin to increase or decrease. As mentioned, in some cases, it may be desirable to cause the phone, tablet, laptop, or other item of value to emit a desired sound (either by its own components or by an attached tracking component) to assist a user to retrieve the item. This capability can be instead of, or in addition to, an alert generated by the alerting component.

In some embodiments, an application installed on a user's mobile device (e.g., a smartphone, tablet, or laptop) is used to enable the mobile device to receive and monitor a “heartbeat” or other signal emitted by a Bluetooth module contained in the alerting component which is in possession of the user. The detection of the heartbeat/signal is used to indicate that the user is in range or nearby the mobile device. When the heartbeat/signal is no longer detected (or its strength has been reduced to a specified level or relative level), the application causes the mobile device to generate a suitable alert, such as one or more of an audible, visual, or vibrational indicator. In addition to, or instead of the mobile device generating an alert, a speaker, haptic alert generator, or visual indicator that is part of the alerting component in the possession of the user may generate an alert. This provides the user with a warning that they may be about to lose their mobile device and causes them to look for it in a defined region (typically a room or region representing the range of the heartbeat/signal).

FIGS. 1(b) and 1(c) are diagrams illustrating certain of the elements of an embodiment of an alerting and/or tracking component 100 that may be attached to an item of value or be in possession of a user, as part of a system for preventing the loss of the item of value. As shown in the figures, in one embodiment, the component 100 is a printed circuit board or other substrate. As shown in FIG. 1(b), the device includes a visual indicator (LED), a source of power (battery), a circuit board, and a source of an audible signal (Speaker). The circuit board contains components that implement the logic of the inventive methods, including a BLE module for use in pairing between component 100 and an item of value, determining when to generate an alert (based on strength of the Bluetooth signal received from a BLE module or similar capability attached to or incorporated into the user's item of value, or on the rate of change of the Bluetooth signal), and the type or types of alerts to generate. FIG. 1(c) illustrates the outer appearance of a possible embodiment, including an encasement 102 and an opening 104 for observing the LED or other visual signal.

FIG. 1(d) is a schematic diagram of a circuit and components that may be used to construct an embodiment of the tracking component described herein. FIG. 1(e) is a flowchart or flow diagram illustrating aspects of a process, operation, method, or function that may be used to assist a person to prevent the loss of an item of value. As shown in FIG. 1(d), the circuitry for a module or device that may be incorporated into or attached to an item of value includes a Bluetooth BLE Module 120, a flash memory module for storing data 122, an antenna 124, and a source of power (either a replaceable battery or charging circuit for an internal battery). As mentioned, the Bluetooth 4.0 standard, also known as Bluetooth Low Energy (BLE), is a short range radio technology, optimized for ultra-low power applications. It is different from Bluetooth classic (BR/EDR), but with similar benefits of robustness, interoperability, and connectivity with smart phones and PCs.

As shown in the flow diagram or flowchart of FIG. 1(e), in a typical use case the interactions between an application installed on a user's mobile device (identified as “Central Application” in the figure) and the logic executed by a “module” incorporated into or attached to an item of value (identified as “Peripheral application” in the figure) include:
After inserting a battery, the BLE module (in the peripheral device) enters an “advertising” state. In this state, an advertise (a form of announcing its presence) packet is being sent every 3 s;
The mobile device (e.g., the smartphone) “listens” for these packets, and, if it wants to establish a connection, it sends a connection request to the BLE module, waits for the response, and then reads the module's preferred connection settings and GATT structure—connection state;
If the module's preferred connection settings are applicable to the mobile device, then the device and BLE module switch to these settings and start data exchange (currently every 2 s)—connected state;
Note that the most power consuming state is the connection state, and the greater the number of connects/disconnects the module has, the less time the battery will maintain sufficient current to power the peripheral device. In some embodiments, there may be 3 battery power levels that may be “read” or determined: strong, low, and not-connected, where the not-connected state generates a notification on the mobile device.
Also note the following behavior(s):
   If device is out of the connection zone—the application will get callback form BLE and process it according to application logic (vibrate, notification, save position etc.);
   If device appears in the connection zone—the application will get callback from BLE and process it (vibrate, notification, etc.)
While connected to device, application will periodically (period depends on device mode—active/sleep) check signal strength. If strength is below threshold (not disconnected yet, but in critical zone)—application will process it according to specified logic (vibrate, notification, etc.). If strength returns to normal value—discard notifications etc.

FIG. 2(a) is a diagram illustrating a embodiment of a component 200 that may be attached to an item of value (and thus serve as a tracking component) or be in possession of a user (and thus serve as an alerting component), as part of a system for preventing the loss of the item of value. As shown in the figures, this embodiment of the component includes batteries 202 as a source of power, a visual indicator such as a LED 204, a BLE module 206, and other elements used to implement the logic used in component 200. As mentioned with reference to FIG. 1(b), the circuit board or substrate may be encased in a suitable material that provides protection for the elements from moisture and damage. FIG. 2(b) is a parts list and illustration of an embodiment of the tracking component of FIG. 2(a).

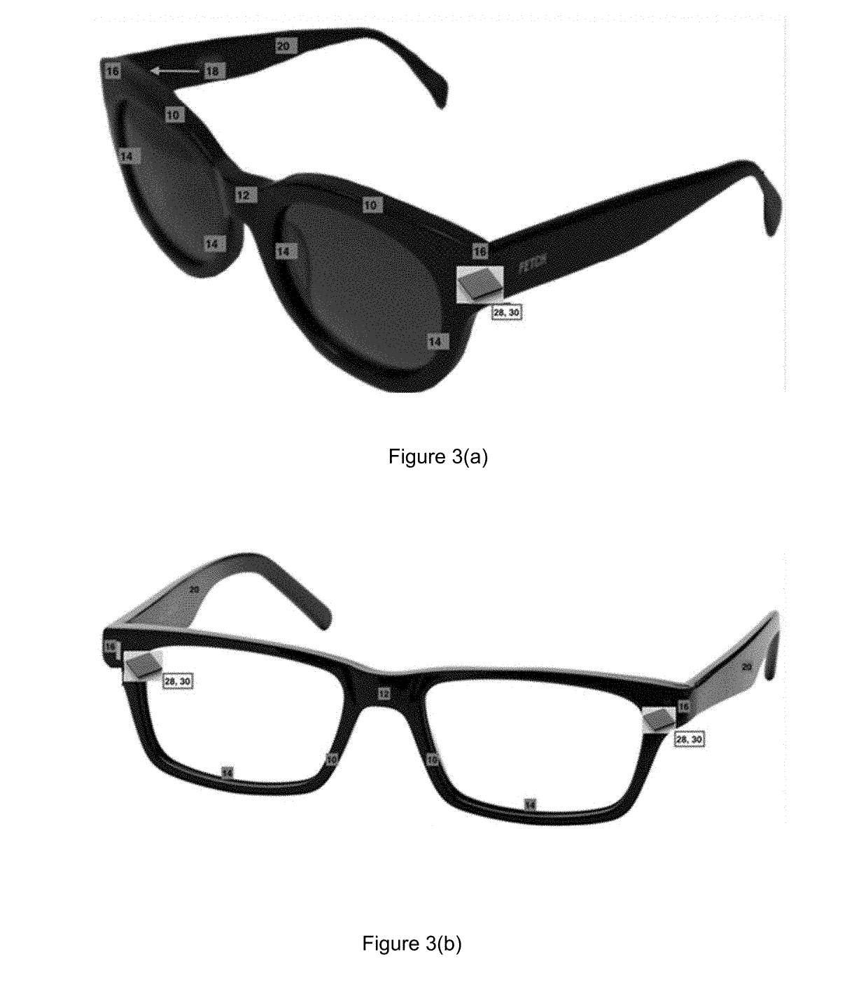

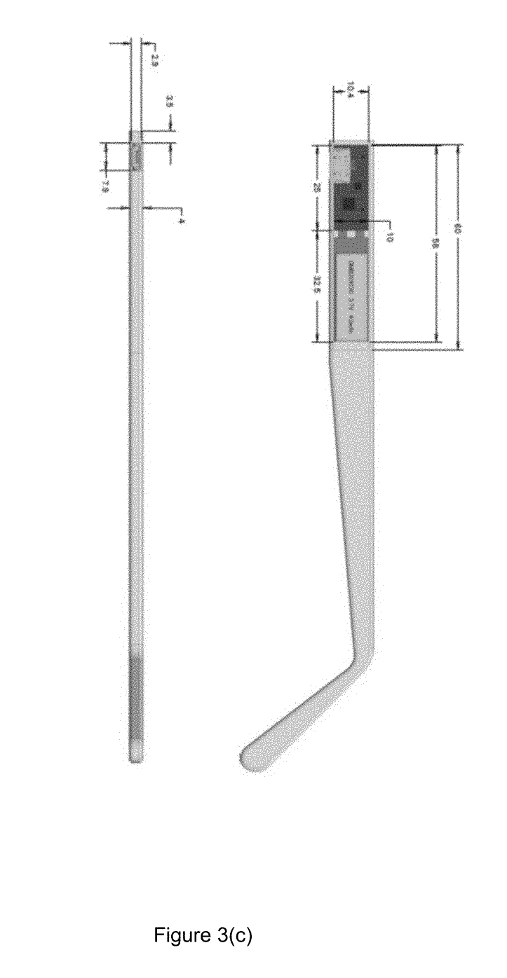

As mentioned, in some embodiments, a BLE module and possibly a source of an alert may be incorporated into a pair of eyeglass frames. FIGS. 3(a) and 3(b) are diagrams illustrating a top angled view of the Fetch Eyewear “Bella” Frame with an embedded Bluetooth module. Note that in addition to the Bluetooth BLE module, a visual indicator, micro-speaker, or haptic signal source may also be embedded or otherwise incorporated into the frames. Note also that the Fetch Eyewear Bella frame is not a requirement of an embodiment of the invention, and is being shown as an example of a frame in which a Bluetooth or similar tracking module could be embedded.

As shown in FIGS. 3(a) and 3(b), an embodiment of a pair of eyeglasses or eyeglass frames that may be used as part of the system and methods described herein may include one or more of the following:
10—Frame Front—Front part of the eyeglass frame that holds the lenses in place and bridges the top of the wearer's nose.
12—Bridge—The area between the lenses that goes over the nose—this supports the majority of the weight of the eyeglasses.
14—Eye Wire/Rims—Part of the frame front into which the lenses are inserted
16—End Pieces—Extensions of the frame front to which the temples are attached.
18—Hinges—Part of the frame that connects the frame front to the temples and allows the temples to swing/move.
20—Temples—Parts of the frame that extend over and/or behind the ears to help hold the frame in place.
24—Nose Pads—Plastic/rubber/silicone pieces that may be attached directly to the frame or to pad arms. They help keep the frame in its proper position.
28—Embedded Bluetooth module with an epoxy encasement—in use, may be activated by a scan of a tag reader.
30—Bluetooth module—contain their own source of power.

As mentioned, in some embodiments, a Bluetooth module (e.g., a BLE module) attached to, incorporated, or embedded in a pair of frames may be used to communicate with a similar module that is attached to, incorporated, or embedded in an item of value; when a signal generated by one of the modules is no longer received by the other module (or decreases in signal strength by a sufficient amount), then an alert is generated to inform the user that they may be leaving the vicinity of the item of value. In this regard, FIG. 3(c) is an illustration of the tracking component embodiment of FIG. 1(a) as it might be embedded or incorporated with the example frames of FIG. 3(a) or 3(b).

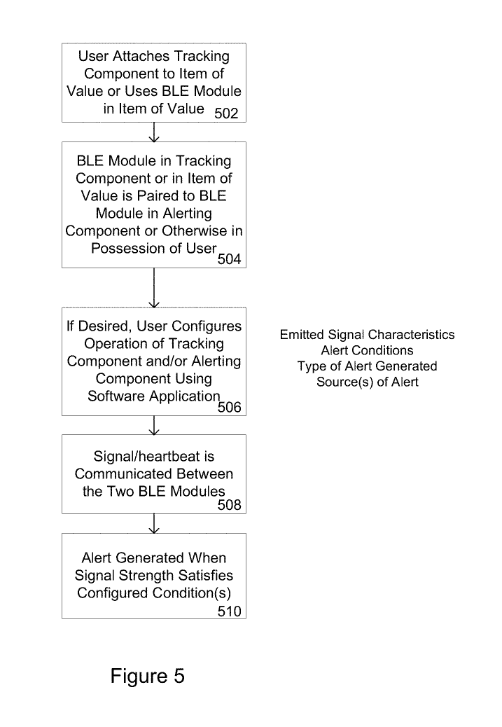

FIG. 5 is a flowchart or flow diagram illustrating a method, process, operation, or function(s) that may be implemented by an embodiment of the inventive system and methods in order to assist a user to not misplace or lose an item of value. The illustrated process includes the following example steps or stages (note that FIG. 1(e) provides a flowchart or flow diagram that may represent certain of the steps or stages shown in FIG. 5, such as step or stage 504):
1) User attaches a tracking component of the type described with reference to FIG. 1 or FIG. 2 to an item of value (as suggested by step or stage 502);
2) A BLE module in the tracking component is paired with a similar module in a user's eyeglass frames, an alerting component, or otherwise in possession of the user (504);
3) If desired, the user may configure one or more aspects of the operation of the tracking or alerting component using a downloaded software application (506)—these aspects may include characteristics of the emitted heartbeat/signal, conditions under which an alert is generated (based on signal strength, decrease in signal strength, etc.), and/or the type of alert generated and the source of the alert (e.g., visual, audible, haptic, whether the alert is generated by a tracking component, a device, an alerting component, etc.);
4) A signal/heartbeat is transmitted between the two BLE modules (508); and
5) When the signal/heartbeat signal strength satisfies a condition for generating an alert, a source of an alert is caused to generate the type or types of alert that were configured (510).

As mentioned, a downloaded software application may be installed on a smartphone or other suitable mobile device (such as a tablet, laptop, etc.) and used to configure one or more of the functions or operations of a tracking component and/or alerting component. In some embodiments, the software application may provide the following UI displays and/or functionality:

Screens/UI Display
Start Screen
Login Screen
Settings/Configuration Screens (Type of Alert, Alert Triggers, source of Alert, etc.)
User Account Screen

Functionality/Capabilities
User registration and authorization
Setup user name, phone and address
Alert type (text, vibration, sound) can be configured by user in the mobile application, as can the Alert generating source (alerting component, tracking component, user device, user frames, etc.)
Setup Alerts based on calendar events (or to mute alerts during a specific type of event)

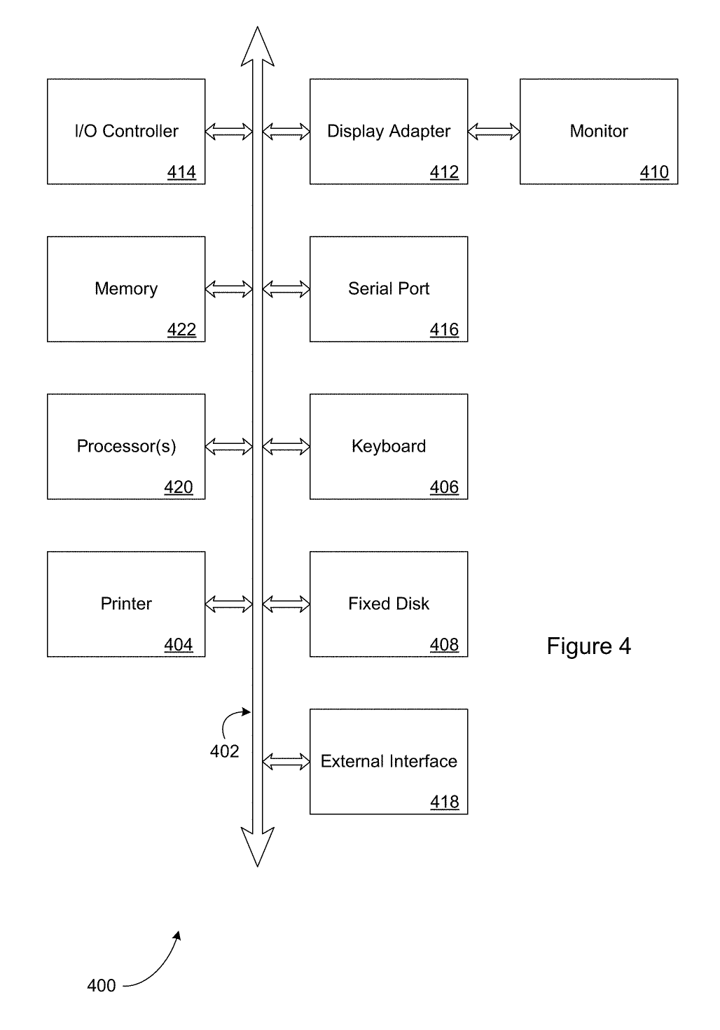

FIG. 4 is a diagram illustrating elements or components some of which may be present in a computing device, mobile device or system configured to implement a method, process, function, or operation in accordance with an embodiment of the invention. In accordance with one embodiment of the invention, the system, apparatus, methods, processes, functions, and/or operations for efficiently managing access to and usage of an extension or application installed on a multi-tenant platform may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system.

As an example, FIG. 4 is a diagram illustrating elements or components that may be present in a computer device or system 400 configured to implement a method, process, function, or operation in accordance with an embodiment of the invention. The subsystems shown in FIG. 4 are interconnected via a system bus 402. Additional subsystems include a printer 404, a keyboard 406, a fixed disk 408, and a monitor 410, which is coupled to a display adapter 412. Peripherals and input/output (I/O) devices, which couple to an I/O controller 414, can be connected to the computer system by any number of means known in the art, such as a serial port 416. For example, the serial port 416 or an external interface 418 can be utilized to connect the computer device 400 to further devices and/or systems not shown in FIG. 4 including a wide area network such as the Internet, a mouse input device, and/or a scanner. The interconnection via the system bus 402 allows one or more processors 420 to communicate with each subsystem and to control the execution of instructions that may be stored in a system memory 422 and/or the fixed disk 408, as well as the exchange of information between subsystems. The system memory 422 and/or the fixed disk 408 may embody a tangible computer-readable medium.

As noted, in some embodiments, the inventive system and methods may be implemented in the form of an apparatus that includes a processing element and set of executable instructions. The executable instructions may be part of a software application and arranged into a software architecture. In general, an embodiment of the invention may be implemented using a set of software instructions that are designed to be executed by a suitably programmed processing element (such as a CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module (e.g., a function or process related to generating a user interface on the mobile device, configuring the heartbeat/signal, configuring the type of alert generated by the device, etc.). Such function, method, process, or operation may also include those used to implement one or more of the following aspects of the inventive system and methods:

As mentioned, the logic contained in the software application (which is typically installed on a user's smartphone or other mobile device) may include one or more of the following configurable parameters or capabilities:
a selection of the preferred type of alert (visual, audible, haptic, text, email);
a selection of the conditions under which each type or the types of alerts are generated or not generated (based on one or more of Bluetooth signal strength, change in Bluetooth signal strength, events noted in a calendaring application, time since previous alert was generated, time since first alert generated, time since first detected decrease in Bluetooth signal, etc.); or
a selection of which components or devices (such as a tracking component attached to an item of value, an alerting component in possession of a user, etc.) are caused to generate an alert when the signal strength between two BLE modules is reduced to a specified level or fraction of an initial value.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A system for assisting a user to reduce the likelihood of misplacing an item of value, comprising:
a software application installed on the user's mobile device, the software application providing the user with one or more user interface displays, the user interface displays including one or more user interface elements by which the user may configure a function of one or both of an alerting component and a tracking component;
an alerting component in the possession of the user, the alerting component including a module capable of transmitting and receiving a Bluetooth Low energy (BLE) signal and a source capable of generating an alert;
a tracking component incorporated in or attached to the item of value, the tracking component including a module capable of transmitting and receiving a Bluetooth Low energy (BLE) signal;
wherein the software application provides the user with an ability to configure
a condition or conditions which, if satisfied, will cause the source capable of generating an alert to generate an alert;
whether the alerting component, tracking component, or both will generate the alert when the condition or conditions are satisfied; and
a type or types of an alert that will be generated when the condition or conditions are satisfied.

2. The system of claim 1, wherein the alerting component is integrated with the user's eyeglass frames.

3. The system of claim 1, wherein the source capable of generating an alert is one or more of a light, a source of an audible alert, or a source of a haptic alert.

4. The system of claim 1, wherein the condition or conditions which, if satisfied, will cause the source capable of generating an alert to generate an alert include one or more a reduction in signal strength by a specified amount, a reduction in signal strength by a specified percentage, or a reduction in signal strength to below a specified level.

5. The system of claim 1, wherein the tracking component is integrated into the user's mobile device and the alerting component is integrated with the user's eyeglass frames.

6. The system of claim 1, wherein the tracking component is encased in a holder and the holder is attached to the item or device, and further, wherein the tracking component includes a source capable of generating an alert.

7. The system of claim 6, wherein the source capable of generating an alert included in the tracking component is one or more of a light, a source of an audible alert, or a source of a haptic alert.

8. The system of claim 1, wherein the type or types of an alert that will be generated when the condition or conditions are satisfied include one or more of a visual alert, an audible alert, or a haptic alert.

9. The system of claim 1, wherein the user's mobile device is one of a smartphone, tablet computer, or laptop computer.

10. A method for assisting a user to reduce the likelihood of misplacing an item of value, comprising:
providing the user with a software application to be installed on the user's mobile device, the software application providing the user with one or more user interface displays, the user interface displays including one or more user interface elements by which the user may configure a function of one or both of an alerting component and a tracking component;
providing the user with an alerting component, the alerting component including a module capable of transmitting and receiving a Bluetooth Low energy (BLE) signal and a source capable of generating an alert;
wherein the software application provides the user with an ability to configure
a condition or conditions which, if satisfied, will cause the source capable of generating an alert to generate an alert; and
a type or types of an alert that will be generated when the condition or conditions are satisfied.

11. The method of claim 10, wherein the alerting component is integrated with the user's eyeglass frames.

12. The method of claim 10, wherein the source capable of generating an alert is one or more of a light, a source of an audible alert, or a source of a haptic alert.

13. The method of claim 10, wherein the condition or conditions which, if satisfied, will cause the source capable of generating an alert to generate an alert include one or more a reduction in signal strength by a specified amount, a reduction in signal strength by a specified percentage, or a reduction in signal strength to below a specified level.

14. The method of claim 10, wherein the user's mobile device is one of a smartphone, tablet computer, or laptop computer.

15. The method of claim 10, wherein the alerting component is integrated with the user's eyeglass frames, and the module capable of transmitting and receiving a Bluetooth Low energy (BLE) signal communicates with a similar module attached to or incorporated in the item of value.

16. The method of claim 15, wherein the similar module is incorporated into the user's mobile device.

17. The method of claim 16, wherein the software application provides the user with an ability to configure whether the alerting component, user's mobile device, or both will generate the alert when the condition or conditions are satisfied.
